(19) United States
(12) Patent Application Publication
(10) Pub. No.: US 2012/0153605 A1
(43) Pub. Date: Jun. 21, 2012

(54) COUNTERWEIGHT SYSTEM

(75) Inventor: Tod L. Hetzel, Bartonville, IL (US)

(73) Assignee: Caterpillar Inc., Peoria, IL (US)

(21) Appl. No.: 13/034,865

(22) Filed: Feb. 25, 2011

Related U.S. Application Data
(60) Provisional application No. 61/424,754, filed on Dec. 20, 2010.

(51) Int. Cl. E02F 9/18; B62D 49/08; B23P 17/04

(52) U.S. Cl. 280/755; 29/428

(57) ABSTRACT

The present disclosure relates to a counterweight system of a machine and method of assembling the counterweight system on the machine. The counterweight system includes a base counterweight and one or more counterweights. The base counterweight and the one or more counterweights comprises a first set of holes and a second set of holes. The base counterweight is coupled to the machine frame. A first counterweight of the one or more counterweights is coupled with the base counterweight through the first set of holes of the first counterweight and the second set of holes of the base counterweight by using at least one bolt. Similarly, a second counterweight of the one or more counterweights and the first counterweight are coupled through first set of holes of the second counterweight and the second set of holes of the first counterweight.

### RELATED APPLICATIONS

This application is based upon and claims the benefit of priority from U.S. Provisional Application No. 61/424,754 by Tod L. Hetzel, filed Dec. 20, 2010, the contents of which are expressly incorporated herein by reference.

### TECHNICAL FIELD

The present disclosure relates to a counterweight system for a machine. More, specifically, the present disclosure relates to an efficient counterweight system to balance the weight of vehicles about the center of gravity.

### BACKGROUND

The front side of heavy vehicles such as tractors becomes heavy at the front when the landfill mass is added to heavy vehicles. Therefore, counterweights are required to be added to heavy vehicles for proper weight balancing. Addition of counterweights improves the stability of the heavy vehicle and thereby improves the vehicle handling by an operator.

Presently there are several ways of attaching counterweight to a vehicle. One way is to attach a single slab counterweight to the vehicle. The slab counterweight can be attached to the vehicle by welding to the vehicle frame. However, the single counterweight slab will not be suitable for all the type of usages of the vehicle. The single counterweight slab can be too heavy as a counterweight for some usages of vehicle or cannot provide adequate counterweight for other usages.

Another existing method is to attach a striker bar box as a counterweight to the vehicle. However, the striker bar box is too light to provide adequate balancing for most of application of the vehicle. Therefore, to provide adequate balancing, an extra counterweight is welded to the striker bar box at a customer site as desired. However, this requires an additional step. Further, the addition of the extra counterweight doesn't ensure proper balancing for all the applications. Furthermore, since the extra weight is welded to the striker bar box, the vehicle carries all the extra weight at all time during its operation. This unnecessarily increases the energy consumption of the vehicle.

Hence, there is a requirement of an improved counterweight addressing the above mentioned limitations.

### SUMMARY OF THE INVENTION

An objective of the present disclosure is to provide a counterweight system configured to provide balancing of a machine.

In an embodiment of the present disclosure, the counterweight system comprises a base counterweight, and one or more counterweights. The base counterweight is coupled to a machine frame such as a striker bar box. The base counterweight and the one or more counterweights have a first set of holes and a second set of holes. The base counterweight is attached to the machine frame by using at least one bolt through first set of holes. It is to be appreciated that the base counterweight can be attached to the machine frame by using an alternate attachment mode such as by welding the base counterweight to the machine frame.

Further, a first counterweight of the one or more counterweights is coupled to the base counterweight. More specifically, the coupling of the first counterweight and the base counterweight is facilitated through the first set of holes of the first counterweight and the second set of holes of the base counterweight. The first counterweight is attached with base counterweight by using at least one bolt. A second counterweight of the one or more counterweights is coupled to the first counterweight. Herein, the coupling of the second counterweight and the first counterweight is facilitated through the second set of holes of the first counterweight and the first set of holes of the second counterweight. The attachment of the second counterweight to the base counterweight is facilitated by at least one bolt. In an embodiment, the base counterweight, the first counterweight, and the second counterweight are attached horizontally.

Furthermore, any number of counterweights can be attached through the first set of hole of one counterweight to the second set of holes of another counterweight by using at least one bolt. The arrangement described above provides for attachment or removal of the counterweights without disturbing the entire assembly of the counterweights.

In an embodiment of the present disclosure, the method for assembling the counterweight system on the machine is provided. The counterweight system comprises the base counterweight and the one or more counterweights. Initially, the base counterweight is coupled to the machine frame. The base counterweight is coupled to the machine frame through the first set of holes of the base counterweight by using at least one bolt. Thereafter, the first counterweight is coupled to the base counterweight through the first set of holes of the first counterweight to the second set of holes of the base counterweight. In another embodiment, the first set of holes of the first counterweight is aligned with the second set of holes of the base counterweight by rotating the first counterweight about an axis. In yet another embodiment, the axis is substantially perpendicular to a plane of the first counterweight and passing through the centre of the first counterweight. The second counterweight is coupled to the first counterweight through the second set of holes of the first counterweight to the first set of holes of the second counterweight by using at least one bolt. In an embodiment, the base counterweight, the first counterweight, and the second counterweight are attached horizontally.

In an embodiment, examples of machine can include but not limited to a heavy vehicle, a truck type tractor, a road paving machine, a wheel loader, a pipelayer, and a crane. In an embodiment, the machine frame is a striker bar box.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present disclosure.

FIG. 1 is an exploded view of a counterweight system for a machine, in accordance with an embodiment of the present disclosure;

FIG. 2 is a perspective view of a base counterweight used in a counterweight system in accordance with an embodiment of the present disclosure;

FIG. 3 is a perspective view of a first counterweight of one or more counterweights, in accordance with one embodiment of the present disclosure;

FIG. 4 is a perspective view of a second counterweight of one or more counterweights, in accordance with an embodiment of the present disclosure; and

FIG. 5 is a flow diagram illustrating a method for assembling a counterweight system on a machine, in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present disclosure.

### DETAILED DESCRIPTION

Before describing the embodiments in detail in accordance with the present disclosure, it should be observed that these embodiments reside primarily in the counterweight system and the method for assembling it. Accordingly, the method steps and the system components have been represented to show only those specific details that are pertinent for an understanding of the embodiments of the present disclosure, and not the details that will be apparent to those with an ordinary skill in the art.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising. Further, the terms “coupling”, “coupled”, “attaching” or “attached” or any other variation therefore are used interchangeably in this document and refers to same meaning and scope.

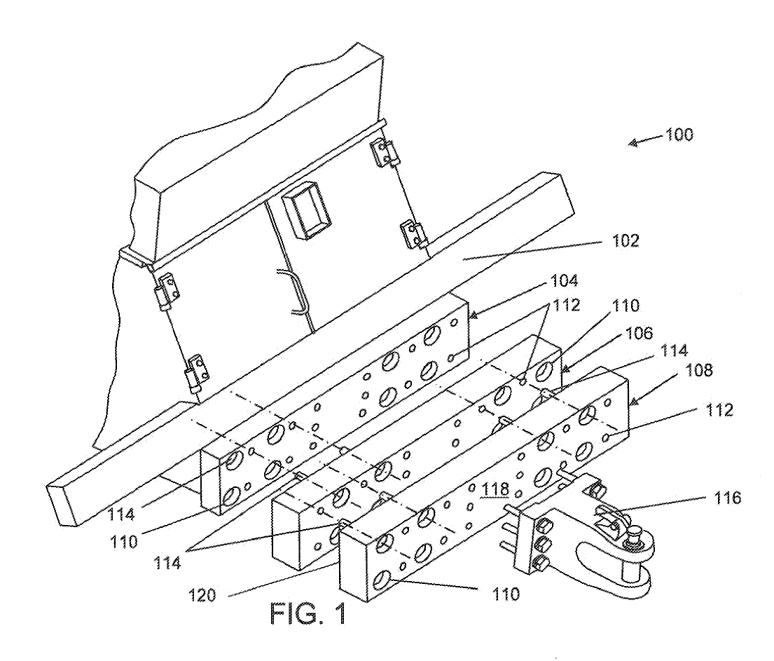

FIG. 1 is an exploded view of a counterweight system 100 for a machine, in accordance with an embodiment of the present disclosure.

The counterweight system 100 comprises a base counterweight 104 and one or more counterweights including a first counterweight 106 and a second counterweight 108.

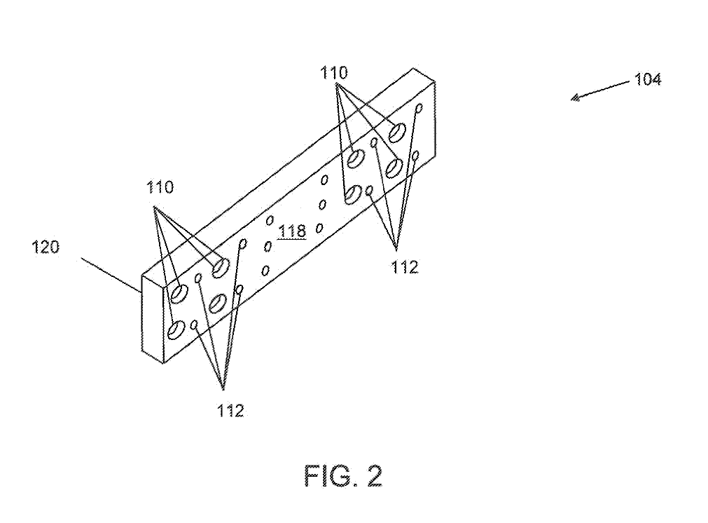

The base counterweight 104 comprises a front face 118 (as shown in FIG. 2), a rear face 120 (as shown in FIG. 2), a first set of holes 110 and a second set of holes 112. In an embodiment, the base counterweight 104 is rectangular in cross-section. The rear face 120 of the base counterweight 104 is coupled to a machine frame 102. The machine frame 102 is present either at a rear side or at a front side of the machine. Examples of machine can include but not limited to a heavy vehicle, a truck type tractor, a road paving machine, a wheel loader, a pipelayer, and a crane. In an embodiment, the machine frame 102 is a striker bar box.

The base counterweight 104 is coupled horizontally to the machine frame 102. The base counterweight 104 is coupled to the machine frame 102 through the first set of holes 110 of the base counterweight 104 by using at least one bolt 114. In an embodiment, the bolt 114 is a countersunk bolt. The examples of bolt 114 further include but not limited to a stud, a flat head bolt, a set screw, and a hexagonal bolt. Further, the one or more counterweights are attached to the front face 118 of the base counterweight 104.

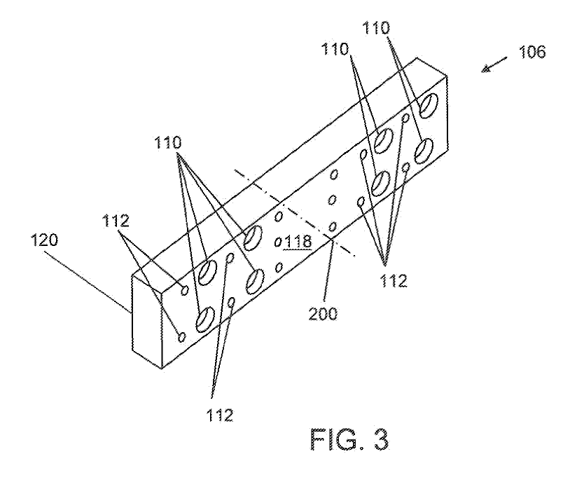

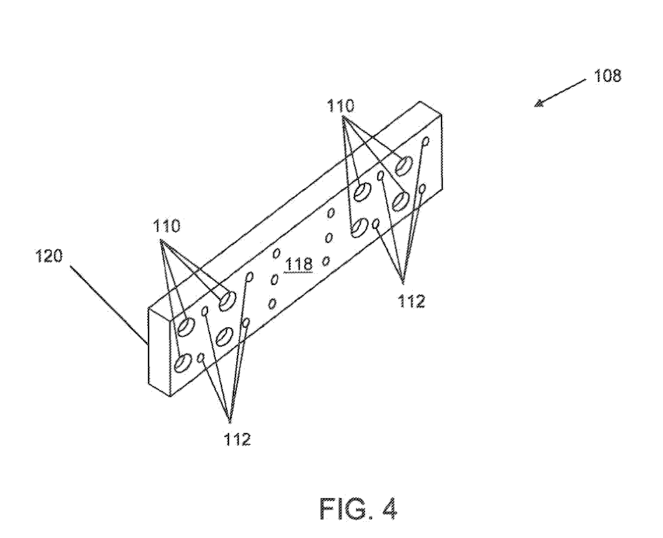

Further, the first counterweight 106 of the one or more counterweights and the second counterweight 108 of the one or more counterweights include the first set of holes 110, the second set of holes 112, the front face 118 (as shown in FIG. 3, and FIG. 4), and the rear face 120 (as shown in FIG. 3, and FIG. 4). In an embodiment, the first counterweight 106, and the second counterweight 108 are rectangular in cross-section. It is to be understood that shape and of the base counterweight and the one or more counterweights can be customized for each machine.

The first counterweight 106 is coupled horizontally to the base counterweight 104. The rear face 120 (as shown in FIG. 3) of first counterweight 106 of the one or more counterweights is coupled with the front face 118 (as shown in FIG. 2) of the base counterweight 104. The first counterweight 106 and the base counterweight 104 are coupled through first set of holes 110 of the first counterweight 106 and the second set of holes 112 of the base counterweight 104 by using at least one bolt 114. In an embodiment, the bolt 114 is a countersunk bolt. The examples of bolt 114 further include but not limited to a stud, a flat head bolt, a set screw, and a hexagonal bolt. The first counterweight 106 is coupled horizontally with the base counterweight 104.

Prior to coupling the first counterweight 106 and the base counterweight 104, the first set of holes 110 of the first counterweight 106 is aligned with the second set of holes 112 of the base counterweight 104. The first set of holes 110 of the first counterweight 106 is aligned with the second set of holes 112 of the base counterweight 104 by rotating the first counterweight 106 about an axis 200 (as shown in FIG. 3). The axis 200 is defined as an axis substantially perpendicular to a plane of the first counterweight 106 and passing through center of the first counterweight 106. In other words, the axis 200 is substantially perpendicular to the front face 118 (as shown in FIG. 3). Further, rotation the first counterweight 106 about the axis 200 leads to alignment of the first set of holes 110 with the second set of holes 112. Thus, both the base counterweight and the one or more counterweights are similar, and rotating a counterweight about the axis 200 leads to alignment of the first set of holes 110 with the second set of holes 112 of the another counterweight. As described above, the first set of holes 110 of the second counterweight 108 are also aligned with the second set of holes 112 of the first counterweight 106, by rotation of the first counterweight about the axis 200.

To explain in detail, the second counterweight 108 is coupled with the front face 118 (as shown in FIG. 3) of the first counterweight 106. The second counterweight 108 and the first counterweight 106 are coupled horizontally in such manner that the rear face 120 of the second counterweight 108 is attached to the front face 118 of the first counterweight 106. The coupling of the first counterweight 106 and the second counterweight 108 is facilitated through the second set of holes 112 of the first counterweight 106 and the first set of holes 110 of the second counterweight 108 by using at least one bolt 114. In an embodiment, the bolt 114 is a countersunk bolt. The examples of bolt 114 further include but not limited to a stud, a flat head bolt, a set screw, and a hexagonal bolt. Further, it can be appreciated that similarly any number of counterweights can be coupled for weight balancing of the machine.

In an embodiment, a locking means 116 retains the base counterweight 104, the first counterweight 106 and the second counterweight 108 to the machine frame 102.

FIG. 2 is a perspective view of the base counterweight 104 used in a counterweight system in accordance with an embodiment of the present disclosure.

The base counterweight 104 comprises the first set of holes 110 and the second set of holes 112. In an embodiment, each of the first set of holes 110 and each of the second set of holes 112 is a through hole. In yet another embodiment, each of the first set of holes 110 and each of the second set of holes 112 is a threaded hole. Each of the first set of holes 110 and each of the second set of holes 112 is circular in profile. The first set of holes 110 and the second set of holes 112 are arranged in an alternative pattern to each other with a predetermined amount of space. In an embodiment, the base counterweight 104 can comprises only first set of holes 110. In another embodiment, the base counterweight 104 can comprises only second set of holes 112. In an exemplary embodiment of the present disclosure, the base counterweight 100 is rectangular in profile.

FIG. 3 is a perspective view of the first counterweight 106 of one or more counterweights, in accordance with an embodiment of the present disclosure.

The first counterweight 106 comprises the first set of holes 110 and the second set of holes 112. In an embodiment, each of the first set of holes 110 and the second set of holes 112 of the first counterweight 106 is a through hole. In another embodiment, each of the first set of holes 110 and each of the second set of holes 112 is a threaded hole. Further, each of the first set of holes 110 and each of the second set of holes 112 is circular in profile. Also, the first set of holes 110 and the second set of holes 112 are arranged in an alternative pattern to each other with a predetermined amount of space. In an exemplary embodiment of the present disclosure, the first counterweight 106 is rectangular in profile. Furthermore, the axis 200 is defined as an axis substantially perpendicular to a plane of the first counterweight 106 and passing through center of the first counterweight 106. In other words, the axis 200 is substantially perpendicular to the front face 118. The first counterweight 106 can rotate about the axis 200.

FIG. 4 is a perspective view of the second counterweight 108 of one or more counterweights, in accordance with an embodiment of the present disclosure.

The second counterweight 108 comprises the first set of holes 102 and the second set of holes 104. In an embodiment, each of the first set of holes 110 and the second set of holes 112 of the second counterweight 108 is a through hole. In another embodiment, each of the first set of holes 110 and each of the second set of holes 112 is a threaded hole. Further, each of the first set of holes 110 and each of the second set of holes 112 is circular in profile. Also, the first set of holes 110 and the second set of holes 112 are arranged in an alternative pattern to each other with a predetermined amount of space. In an exemplary embodiment of the present disclosure, the second counterweight 108 is rectangular in profile.

In an embodiment of the present disclosure, the first counterweight 106 is rotated about the axis 200 to obtain the second counterweight 108. In another embodiment of the present disclosure, an angle of rotation of the first counterweight 106 is 180°.

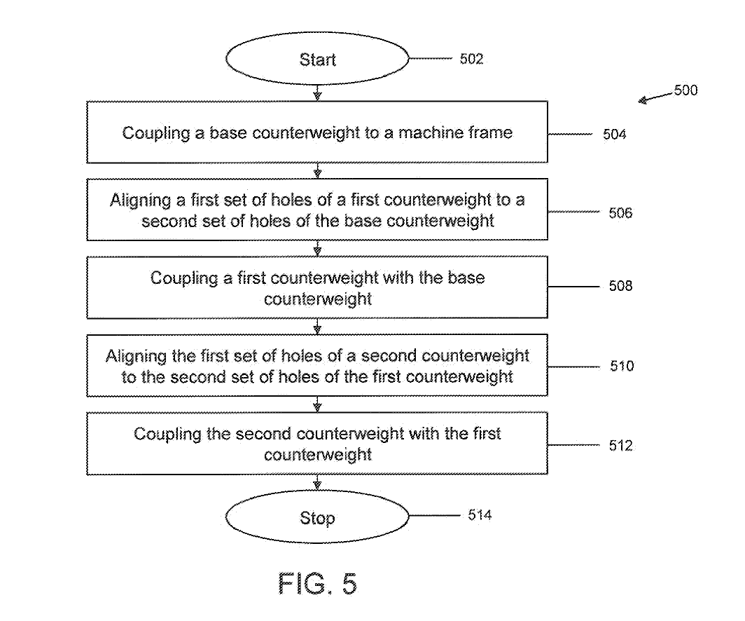

FIG. 5 is a flow diagram illustrating a method 500 for assembling the counterweight system 100 on the machine, in accordance with an embodiment of the present disclosure.

The Method 500 initiates at step 502. At step 504 the base counterweight 104 is coupled horizontally to the machine frame 102. The base counterweight 104 and the machine frame 102 are coupled by attaching the rear face 120 of the base counterweight 104 with the machine frame 102. The base counterweight 104 is coupled with the machine frame 102 through the first set of holes 112 by using at least one bolt 114. In an embodiment, the bolt 114 is a countersunk bolt. The examples of bolt 114 further include but not limited to a stud, a flat head bolt, a set screw, and a hexagonal bolt.

Thereafter, at step 506, the first set of holes 110 present in the first counterweight 106 is aligned to the second set of holes 112 present in the base counterweight 104. Further, the first set of holes 110 of the first counterweight 106 is aligned with the second set of holes 112 of the base counterweight 104 by rotating the first counterweight 106 about the axis 200. The axis 200 is substantially perpendicular to a plane of the first counterweight 106 and passes through the centre of the first counterweight 104. In another words, the axis 200 is substantially perpendicular to the front face 118 of the first counterweight 106 and passes through centre of the front face 118 of the first counterweight 106. In an exemplary embodiment, the first set of holes 110 of the first counterweight 106 is aligned with the second set of holes 112 of the base counterweight 104 by rotating the first counterweight 106 by 180 degree about the axis 200.

At Step 508, the first counterweight 106 is coupled with the base counterweight 104. In an embodiment, the first counterweight 106 and the base counterweight 104 are coupled horizontally. The first counterweight 106 and the base counterweight 104 are coupled by attaching the front face 118 of the base counterweight 104 with the rear face 120 of the first counterweight 106. The first counterweight 106 is coupled to the base counterweight 104 through the first set of holes 110 of the first counterweight 106 and the second set of holes 112 of the base counterweight 104 by using at least one bolt 114. In an embodiment, the bolt 114 is a countersunk bolt. The examples of bolt 114 further include but not limited to a stud, a flat head bolt, a set screw, and a hexagonal bolt.

At step 510, the first set of holes 110 of the second counterweight 108 are aligned with the second set of holes 112 of the first counterweight 106. The first set of holes 110 of the second counterweight 108 is aligned with the second set of holes 112 of the first counterweight 106 by rotating the first counterweight 106 about the axis 200.

At a step 512, the second counterweight 108 is coupled with the first counterweight 106. In an embodiment, the first counterweight 106 and the second counterweight 108 are coupled horizontally. The first counterweight 106 and the second counterweight 108 are coupled by attaching the front face 118 of the first counterweight 106 with the rear face 120 of the second counterweight 108. The second counterweight 108 is coupled with the first counterweight 106 through the second set of the holes 112 of the first counterweight 106 and the first set of holes 110 of the second counterweight 108 by using at least one bolt 114. Further, it can be appreciated that similarly any number of counterweights can be attached for balancing the machine. Also, it can be understood by the person skilled in the art that the base counterweight and the one or more counterweight can be attached vertically to the machine frame.

The above described counterweight system provides an easier means to add or remove counterweights. The counterweight can be attached or removed easily without disturbing the entire assembly of the counterweights. This increases the flexibility of the system as well as reduces the time required for attachment and removal of counterweights. The system further enables easy adjustment of the counterweight system depending on the type of application. In other words, the number of counterweights can be easily adjusted depending on the type of vehicle. Further, as the cantilever increases, less counterweight are required for balancing the machine. The less weight on a machine, the less power the machine needs to move and less fuel consumption.

Various embodiments of the present disclosure offer one or more advantages. The present disclosure provides for a counterweight system. It is expected that one of ordinary skill, notwithstanding possibly significant effort and many design choices motivated by, for example, available time, current technology and economic considerations, when guided by the concepts and principles disclosed herein, will be readily capable of generating such products with minimal experimentation.

In the foregoing specification, the disclosure and its benefits and advantages have been described with reference to specific embodiments. However, one of ordinary skill in the art would appreciate that various modifications and changes can be made without departing from the scope of the present disclosure, as set forth in the claims below. Accordingly, the specification and figures are to be regarded in an illustrative rather than a restrictive sense, and all such modifications are intended to be included within the scope of the present disclosure. The benefits, advantages, solutions to problems, and any element(s) that may cause any benefit, advantage or solution to occur or become more pronounced are not to be construed as critical, required or essential features or elements of any or all the claims. The disclosure is defined solely by the appended claims, including any amendments made during the pendency of this application, and all equivalents of those claims, as issued.

What is claimed is:

1. A counterweight system being configured to provide balancing of a machine, the counterweight system comprising:
a base counterweight, the base counterweight comprising a first set of holes and a second set of holes, wherein the base counterweight is coupled with a machine frame;
one or more counterweights, each counterweight of the one or more counterweights comprising the first set of holes and the second set of holes;
a first counterweight of the one or more counterweights, the first counterweight being coupled with the base counterweight wherein the coupling is facilitated through the first set of holes of the first counterweight and second set of holes of the base counterweight; and
a second counterweight of the one or more counterweights, the second counterweight being coupled with the first counterweight wherein coupling is facilitated through the second set of holes of the first counterweight and the first set of holes of the second counterweight.

2. The counterweight system according to claim 1, wherein the first counterweight and the base counterweight are coupled by aligning the first set of holes of the first counterweight with the second set of holes of the base counterweight.

3. The counterweight system according to claim 2, wherein the first set of holes of the first counterweight is aligned with the second set of holes of the base counterweight by rotating the first counterweight about an axis, the axis being substantially perpendicular to a plane of the first counterweight and passing through the centre of the first counterweight.

4. The counterweight system according to claim 1, wherein base counterweight and each counterweight of the one or more counterweights are coupled horizontally.

5. The counterweight system according to claim 1, the first set of holes is attached with second set of holes by using at least one bolt.

6. The bolt according to claim 6, wherein the bolt is a countersunk bolt.

7. The counterweight system according to claim 1, wherein the each hole of the first set of holes and the second set of holes is a through hole.

8. A method for assembling a counterweight system on a machine, the counterweight system comprising a base counterweight and one or more counterweights, the base counterweight and each counterweight of the one or more counterweights comprising a first set of holes and a second set of holes, the method comprising:
coupling the base counterweight with a machine frame;
coupling a first counterweight of the one or more counterweights with the base counterweight, wherein the coupling is facilitated through the first set of holes of the first counterweight and the second set of holes of the base counterweight; and
coupling a second counterweight of the one or more counterweights with the first counterweight, wherein the coupling is facilitated through the second set of holes of the first counterweight and the first set of holes of the second counterweight.

9. The method according to claim 8, the first counterweight and the base counterweight are coupled by aligning the first set of holes of the first counterweight with the second set of holes of the base counterweight.

10. The method according to claim 9, wherein the first set of holes of the first counterweight is aligned with the second set of holes of the base counterweight by rotating the first counterweight about an axis, the axis being substantially perpendicular to a plane of the first counterweight and passing through the centre of the first counterweight.

11. The method according to claim 8, wherein the first set of holes is attached with second set of holes by using at least one bolt.

12. The bolt according to claim 11, wherein the bolt is a countersunk bolt.

13. The method according to claim 8, wherein the base counterweight and each counterweight of the one or more counterweights are coupled horizontally.

14. The method according to claim 8, wherein the each hole of the first set of holes and the second set of holes is a through hole.

15. A counterweight system being configured to provide balancing of a machine, the counterweight system comprising:
a base counterweight, the base counterweight comprising a first set of holes and a second set of holes, wherein the base counterweight is coupled with a machine frame;
one or more counterweights, each counterweight of the one or more counterweights comprising the first set of holes and the second set of holes;
a first counterweight of the one or more counterweights, the first set of holes of the first counterweight is aligned with the second set of holes of the base counterweight by rotating the first counterweight about an axis, the first counterweight being coupled with the base counterweight through the first set of holes of the first counterweight and second set of the holes of the base counterweight thereon;
a second counterweight of the one or more counterweights, the second counterweight coupled with the first counterweight wherein the coupling is facilitated by attaching the second counterweight with the first counterweight through the second set of holes of the first counterweight and the first set of holes of the second counterweight.

16. The counterweight system according to claim 15, wherein the axis is substantially perpendicular to a plane of the first counterweight and passing through the centre of the first counterweight.

17. The counterweight system according to claim 15, wherein the first set of holes is attached with second set of holes by using at least one bolt.

18. The bolt according to claim 17, wherein the bolt is a countersunk bolt.

19. The counterweight system according to claim 15, wherein the base counterweight and each of the one or more counterweights are coupled horizontally.

20. The counterweight system according to claim 15, wherein the each hole of the first set of holes and the second set of holes is a through hole.
